(19) United States
(12) Patent Application Publication
(10) Pub. No.: US 2014/0188752 A1
(43) Pub. Date: Jul. 3, 2014

(54) RESPONSIBLE PACKAGING AND LABELING GRADING CERTIFICATION SYSTEM AND METHOD

(71) Applicant: RESPONSIBLE PACKAGING INSTITUTE, LLC, Green Lake, WI (US)

(72) Inventors: Michael White, Green Lake, WI (US); Michael Sisko, Windermere, FL (US)

(73) Assignee: Responsible Packaging Institute, LLC, Green Lake, WI (US)

(21) Appl. No.: 13/842,845

(22) Filed: Mar. 15, 2013

Related U.S. Application Data
(60) Provisional application No. 61/747,111, filed on Dec. 28, 2012.

(51) Int. Cl. G06Q 10/08

(52) U.S. Cl. CPC G06Q 10/083
USPC 705/337

(57) ABSTRACT

A Responsible Packaging System and Method is provided to indicate whether responsible practices are being incorporated into product packaging. Specifically, a system and method is outlined which analyzes and monitors labeling and packaging activity at regular intervals; scores, grades and certifies packaging and labeling according to responsible packaging predetermined criteria; and determines a certified grade based on the package and labels performance relative to responsible packaging and labeling standards.

This application claims the benefit of previously filed U.S. Provisional Application 61/747,111 filed Dec. 28, 2012.

### BACKGROUND

In an effort to identify environmentally responsible packaging, a systematic process is provided for evaluating, ranking, and classifying packaging methods, materials, labels and designs to yield a quantifiable grade for the packager's performance. The grade is determined by means of an analysis which considers a variety of factors. Specifically, the process evaluates product packaging by weighing, measuring, and analyzing contents in regard to its respective packaging and formulates a grade, score or ranking (hereinafter simply “grade”). Based upon the grade, certification for each package is determined based on predetermined criteria. In addition, a grade is awarded to the packager, based on a responsibly packaged quotient, a determination of the value provided to the retailer, and/or consumer, and a measure of the reduction in the product's carbon footprint. A grading system is provided to compile this information and generate the above mentioned grade. By providing a system and method for predicting retailer and consumer satisfaction, packaged goods companies are given broad incentives to generate higher levels of environmentally friendly packaging.

Consumer products are packaged in many different ways as a means to provide consumers with perishable and non-perishable goods. One positive example of such packaging exists in the beverage industry, i.e. drinks are packaged in a fully recyclable aluminum container that exhibits a high product fill ratio that further, when consumed, leaves very minimal product waste. Other consumer products such as cereals are typically packaged within a package, i.e. a liner, contained inside a box where fill ratios are not quite as high. Another example is over-the-counter medications or vitamins packaged in a half filled plastic container enclosed by an outer box. In a myriad of ways, products are packaged for the purpose of conveyance and advertisement, but not all methods of packaging are beneficial to the consumer and to the environment.

Well-designed packaging is intended to result in purchased products that are clean and undamaged. However retail packaging has a dual purpose: 1) protecting a product, and 2) marketing the product in order to make a sale. The marketing of the product through packaging is the primary driver of over-packaging, i.e. the inefficient use of packaging materials. On store shelves, manufacturing companies wage a financial battle for shelf space and consumer attention. The competition to obtain and retain shelf space reinforces the desire to oversize packages in order that the product is favorably perceived by the consumer whether the container truly represents its contents held. Over-packaging for the sake of shelf appeal wastes raw materials which ultimately winds up being incinerated, dumped in oceans, or disposed of in landfills. A larger package creates a larger ‘billboard’ for advertising and often gives consumers the illusion of greater quantity or value. In this regard, there is a need to educate consumers regarding reasonable and necessary packaging, and what is simply being misused to market a product. Stated differently, there is a need to identify and promote responsible packaging practices in a manner easily understood by the consumer.

Excess packaging plays an unfortunate role in the state of our environment. According to the Environmental Protection Agency (EPA), in 2010, the average American produced 4.3 pounds of waste each day, or approximately 1,570 pounds each year. The waste produced in America annually could fill a line of garbage trucks that stretches from the earth to the moon. In weight, the population of the United States produced over 250 million tons of waste in 2010 alone. The United States represents only 6% of the world's population, yet it produces half of the world's garbage. According to the EPA, packaging makes up 30% of America's trash—the largest portion of municipal solid waste (MSW) generated. If all of this trash produced in just one year was buried, it would fill a hole the size of a football field 100 miles deep.

If manufacturers had an incentive not to over-package, they could benefit financially from the potential decrease in shipping and resource costs, and generate consumer goodwill. There is a need for manufacturers to address packaging excess and to develop packaging that protects products while using as little energy and resources as possible. There is further need to gain worldwide competitive advantage for manufacturers who can reduce raw materials costs, reduce shipping costs, and reduce inventory costs by migrating towards environmentally friendly initiatives and ultimately attracting retailers who will also benefit from responsible packaging.

If retailers had the means to easily identify and reward manufacturers that provide responsible packages, those same retailers would reap meaningful benefits. Retailers that offer their customers responsibly packaged goods gain greater in-store flexibility to arrange stores in a way that optimizes revenue-per-square-foot. In addition, retailers that offer responsibly packaged products generate consumer goodwill and, objectively, greater sales from consumers seeking clearly labeled, certified responsible packaged products. There is a need for a system which clearly identifies best-in-class responsible packaging, thus enabling retailers to gain flexibility in merchandising, increase revenue-per-square-foot, reduce inventory costs, and generate consumer goodwill.

The USDA has developed commodity standards and grades to provide a means for measuring levels of quality and value for agricultural commodities. These standards provide a basis for domestic and international trade, while also promoting efficiency in marketing and procurement. The USDA provides quality standards for agricultural products such as cotton, dairy, fruits and vegetables, livestock, poultry, nuts, and processed foods. The USDA has developed strict measures of quality for products such as grains, rice, corn, and beans. The quality grading is based on the standards developed for each product. Quality grades further provide a common language among buyers and sellers, which in turn assures consistent quality for consumers. The USDA also offers quality assessment testing of grain, corn, rice, pulses and processed commodities. These assessments are valuable, but do not contemplate (i) the packaging size relative to the contents held, i.e. fill ratio, (ii) the recyclability of the packaging materials, nor (iii) the shelf life of the package and product. It is worthwhile to note that the longer the shelf life, the longer the timeframe before the discarded product and package find their way to a landfill. As outlined above, the USDA is primarily concerned with the quality of goods and commodities produced in the US, and does not consider or evaluate the related packaging or shelf life expectancy.

The Food and Drug Administration (FDA) provides regulation through the Federal Food, Drug and Cosmetic Act (FD&C Act) and Fair Packaging and Labeling Act (FPLA). Informed consumers are essential to the fair and efficient functioning of a free market economy. Packages and their labels should enable consumers to obtain accurate information as to the quantity of the contents and should facilitate value comparisons. Therefore, the United States Congress has declared it a policy to assist consumers and manufacturers in reaching these goals in the marketing of consumer goods. Consequently, it is unlawful to use nonconforming labels, or to engage in packaging or labeling of any consumer commodity in a manner contrary to this act.

The above listed Fair Packaging and Labeling Act provides several requirements. Specifically, the act requires that: the commodity shall bear a label specifying the identity of the commodity and the name and place of business of the manufacturer, packer, or distributor; the net quantity of contents (in terms of weight or mass, measure, or numerical count) shall be separately and accurately stated in a uniform location upon the principal display panel of that label using the most appropriate units of both the customary inch/pound system of measure; the separate label statement of net quantity of contents appearing upon or affixed to any package, if on a package labeled in terms of weight, shall be expressed in pounds with any remainder in terms of ounces or common or decimal fractions of the pound; or in the case of liquid measure, in the largest whole unit (quarts, quarts and pints, or pints, as appropriate) with any remainder in terms of fluid ounces or common or decimal fractions of the pint or quart; if on a random package, may be expressed in terms of pounds and decimal fractions of the pound carried out to not more than three decimal places and is not required to, but may, include a statement in terms of the SI metric system carried out to not more than three decimal places; if on a package labeled in terms of linear measure, shall be expressed in terms of the largest whole unit (yards, yards and feet, or feet, as appropriate) with any remainder in terms of inches or common or decimal fractions of the foot or yard; if on a package labeled in terms of measure of area, shall be expressed in terms of the largest whole square unit (square yards, square yards and square feet, or square feet, as appropriate) with any remainder in terms of square inches or common or decimal fractions of the square foot or square yard; shall appear in conspicuous and easily legible type in distinct contrast (by topography, layout, color, embossing, or molding) with other matter on the package; shall contain letters or numerals in a type size which shall be established in relationship to the area of the principal display panel of the package, and uniform for all packages of substantially the same size; and shall be so placed that the lines of printed matter included in that statement are generally parallel to the base on which the package rests as it is designed to be displayed; and the label of any package of a consumer commodity which bears a representation as to the number of servings of such commodity contained in such package shall bear a statement of the net quantity (in terms of weight or mass, measure, or numerical count) of each such serving. Whenever the promulgating authority (currently the Secretary of Health and Human Services, and the Federal Trade Commission) determines that regulations containing prohibitions or requirements are necessary to prevent the deception of consumers or to facilitate value comparisons as to any consumer commodity, such authority shall promulgate with respect to that commodity regulations effective to 1) establish and define standards for characterization of the size of a package enclosing any consumer commodity, which may be used to supplement the label statement of net quantity of contents of packages containing such commodity, but this paragraph shall not be construed as authorizing any limitation on the size, shape, weight or mass, dimensions, or number of packages which may be used to enclose any commodity; 2) regulate the placement upon any package containing any commodity, or upon any label affixed to such commodity, of any printed matter stating or representing by implication that such commodity is offered for retail sale at a price lower than the ordinary and customary retail sale price or that a retail sale price advantage is accorded to purchasers thereof by reason of the size of that package or the quantity of its contents; 3) require that the label on each package of a consumer commodity (other than one which is a food) bear (A) the common or usual name of such consumer commodity, if any, and (B) in case such consumer commodity consists of two or more ingredients, the common or usual name of each such ingredient listed in order of decreasing predominance, but nothing shall be deemed to require that any trade secret be divulged; or 4) prevent the nonfunctional-slack-fill of packages containing consumer commodities. A package shall be deemed to be non-functionally slack-filled if it is filled to substantially less than its capacity for reasons other than (A) protection of the contents of such package, or (B) the requirements of machines used for enclosing the contents in such package. Whenever the Secretary of Commerce determines that there is undue proliferation of the weights or masses, measures, or quantities in which any consumer commodity or reasonably comparable consumer commodities are being distributed in packages for sale at retail and such undue proliferation impairs the reasonable ability of consumers to make value comparisons with respect to such consumer commodity or commodities, he shall request manufacturers, packers, and distributors of the commodity or commodities to participate in the development of a voluntary product standard for such commodity or commodities under the procedures for the development of voluntary products standards established by the Secretary. Such procedures shall provide adequate manufacturer, packer, distributor, and consumer representation. If (1) after one year after the date on which the Secretary of Commerce first makes the request of manufacturers, packers, and distributors to participate in the development of a voluntary product standard, he determines that such a standard will not be published pursuant to the provisions of such subsection, or (2) if such a standard is published and the Secretary of Commerce determines that it has not been observed, he shall promptly report such determination to the Congress with a statement of the efforts that have been made under the voluntary standards program and his recommendation as to whether Congress should enact legislation providing regulatory authority to deal with the situation in question. No regulation adopted precludes the continued use of returnable or reusable glass containers for beverages in inventory or with the trade as of the effective date of this Act, nor shall any regulation preclude the orderly disposal of packages in inventory or with the trade as of the effective date of such regulation. Any consumer commodity which is a food, drug, device, or cosmetic, which is introduced or delivered for introduction into commerce in violation of any of the provisions, or the regulations issued, shall be deemed to be misbranded within the meaning of the Federal Food, Drug, and Cosmetic Act. Any violation of any of the provisions of, or the regulations issued pursuant to, with respect to any consumer commodity which is not a food, drug, device, or cosmetic, shall constitute an unfair or deceptive act or practice in commerce in violation of this title and shall be subject to enforcement of this title. In the case of any imports into the United States of any consumer commodity covered by the Fair Packaging and Labeling Act, the provisions shall be enforced by the Secretary of the Treasury pursuant to the Federal Food, Drug, and Cosmetic Act.

The above regulation and information, while helpful, does not provide the consumer, the manufacturer, distributor or retailer the ability to easily identify whether a product has been responsibly packaged. These regulations are valuable, but do not clearly grade the packaging size relative to the contents held, i.e. fill ratio, nor the recyclability of the packaging materials, nor the shelf life of the package and product. As stated above, the longer the shelf life, the longer the timeframe before the discarded product and package find their way to a landfill.

Proper labeling is an important aspect of placing a product on the market. As discussed above, The FDA regulates labeling under the authority of both the Federal Food, Drug, and Cosmetic Act (FD&C Act) and the Fair Packaging and Labeling Act (FPLA). These laws and their related regulations are intended to protect consumers from health hazards and deceptive practices, and to help consumers make informed decisions regarding product purchase. It is generally illegal to introduce misbranded products into interstate commerce, and such products are subject to regulatory action. Some of the methods a product can become misbranded are: 1) its labeling is false or misleading, 2) its label fails to provide required information, 3) its required label information is not properly displayed, or 4) its labeling violates requirements of the Poison Prevention Packaging Act of 1970. It is important to note that the FDA does not pre-approve product labeling. Neither the FD&C Act nor the FPLA requires labeling to undergo pre-market approval by the FDA. It is the manufacturer's and/or distributor's responsibility to ensure that products are labeled properly. It is thus obvious that labeling is an integral part of packaging, and a failure to comply with the above listed acts is problematic. That said, it is problematic for consumers if the labeling is confusing or difficult to comprehend even when all legal requirements are complied with.

Failure to comply with labeling requirements results in a misbranded product. Although differing standards exist, the following information must generally appear on the principal display panel: 1) An identity statement indicating the nature and use of the product by means of either the common or usual name, a descriptive name, a fanciful name understood by the public, or an illustration; and 2) An accurate statement of the net quantity of contents in terms of weight, measure, numerical count, or a combination of numerical count and weight or measure. In addition, the following information must generally appear on an information panel: 1) the name and place of business—this may be the manufacturer, packer, or distributor; 2) a distributor statement—if the name and address are not those of the manufacturer, the label must say “Manufactured for . . . ” or “Distributed by . . . ”; (3) a listing of material facts—the failure to reveal material facts is one form of misleading labeling and therefore makes a product misbranded (e.g. directions for safe use are typically required if a product could be unsafe if used incorrectly); 4) a warning and caution statements—these must be prominent and conspicuous, i.e. the FD&C Act and related regulations specify warning and caution statements related to specific products. In addition, products that may be hazardous to consumers must bear appropriate label warnings (e.g. flammable products), and 5) a listing of ingredients—if the product is marketed on a retail basis to consumers even if it is labeled “For professional use only”, or words to that effect; the ingredients must appear on an information panel, in descending order of predominance. As an alternative, when products are distributed on a mail-order basis, the package mailed to the consumer may contain readily visible instructions for locating the ingredient declaration, such as in a product catalog (currently interpreted as including a website), or instructions for requesting a copy of the ingredient declaration. Mail-order distributors must respond promptly to such requests. Once again, the above regulation and information is helpful, but does not provide the consumer, the manufacturer, distributor or retailer the ability to easily identify whether a product has been responsibly packaged. These regulations also do not clearly grade the packaging size relative to the contents held, i.e. fill ratio, nor the recyclability of the packaging materials, nor the shelf life of the package and product.

In sum, existing packaging schemes offer customers relevant information about the product they are purchasing, but not complete information. There is a need for additional information such as a third party certification or grading to build awareness and appreciation for the positive impact of responsible product packaging. Using rigorous testing and certification protocols while working collaboratively with manufacturers, distributors and retailers, such a certification or grading process would quickly provide a consumer centric approach to responsible packaging. An approach is needed that will support and promote responsible packaging along with a rationalization for quickly driving waste, inefficiency and confusion out of consumer product packaging. Such an approach would improve the integrity of consumer packaging while benefiting the environment. Further, it would give consumers the confidence in knowing that their purchased product is responsibly packaged with integrity, and that environmental waste has been reduced in a mathematical manner.

None of the existing packaging and labeling methods provide customers with clear confirmation that the packaging size relative to the contents held, i.e. fill ratio, nor the recyclability of the packaging materials, nor the shelf life of the package and product have been optimized for the consumer and the environment. While customers appreciate the existence of labeling regulations, they do not have the additional information that the invention will provide to complete consumer information through the entire product's life cycle.

Unquestionably, consumers can be motivated by the knowledge that their purchasing decisions will help reduce their carbon footprint and reduce the overwhelming amount of trash Americans dispose of daily—most of which ends up in landfills, the atmosphere, or our oceans. Should such refuse eventually leach into the water supply, it could potentially pose significant health risks to society. By providing a point of purchase means for the consumer to identify efficiency in packaging and an incentive to manufacturers to reduce excess packaging, significant environment improvements can be achieved. The primary benefit of such a process would reduce the amount of papers, plastics, and metals which ultimately are disposed. Additional benefits include less packaging thus allowing retailers to have greater flexibility in setting their stores, manufacturers spending less on resources and shipping, and consumers benefiting from higher product fill ratios and a cleaner environment.

There is a need to provide manufacturers, retailers and consumers with a certified grade or score that identifies the degree to which a product has been packaged responsibly. There is also a need for a system and method to inform consumers that extends beyond the existing packaging and labeling information and regulation, and directly addresses the impact of the product and its prospective purchase on the environment at the end of the product's life cycle.

### SUMMARY

For the reasons outlined above, a methodology has been developed to encourage responsible packaging practices, and to motivate the improvement of packaging design in a manner that addresses both consumer needs and environmental concerns. The example processes and systems provide an innovative eco-friendly method to improve the design of packaging systems and to reduce the overall use of resources while maintaining package safety and cleanliness. The exemplary responsible packaging system and method demonstrates the clear commitment to responsible packaging. The process defines and illustrates the initiatives vital to businesses in making sustainable packaging goals achievable. The example evaluation scheme considers different factors and requirements that packaging must fulfill on behalf of the retailer, consumer and the environment, and calculates a performance-based score of the packaging analyzed relative to existing responsible packaging practices and standards.

### BRIEF DESCRIPTION OF THE DRAWINGS

FIG. 1 is a schematic block diagram illustrating the various components of one example system and the information flow between parties.

FIG. 2 is a flow diagram illustrating the various inputs or considerations provided to one example scoring scheme.

FIG. 3 is an alternate flowchart illustrating the dataflow for an example responsible packaging evaluation.

### DESCRIPTION OF EXAMPLE EMBODIMENTS

The Responsible Packaging System and Method, discussed in further detail below, provides one example of a systematic approach and incentive for responsible packaging design leading to best practices in responsible packaging and contributing to the development of high quality, consistent, and coordinated methods in responsible packaging designs. The exemplary Responsible Packaging System and Method described below provides a methodology to consider the many factors involved, and develop a score or grade for the product packaging. Many of these factors are discussed below in further detail and consider or incorporate several responsible packaging principles, guidelines or practices (the “responsible packaging principles”). Naturally, several alternative or additional principles could be added or included.

Generally speaking, the example Responsible Packaging System and Method considers, evaluates and/or measures multiple characteristics of product packaging. The various characteristics considered may include physical characteristics, materials characteristics, characteristics of the relationship between the product and the packaging, use characteristics, and producer characteristics. For each of these characteristics, a measure or score can be created. The score can then be indexed against industry standards or established best practices. With all of this information, an overall responsible packaging score can be calculated using a predetermined process. The calculated score thus provides an objective measure of the packaging from an environmental responsibility perspective.

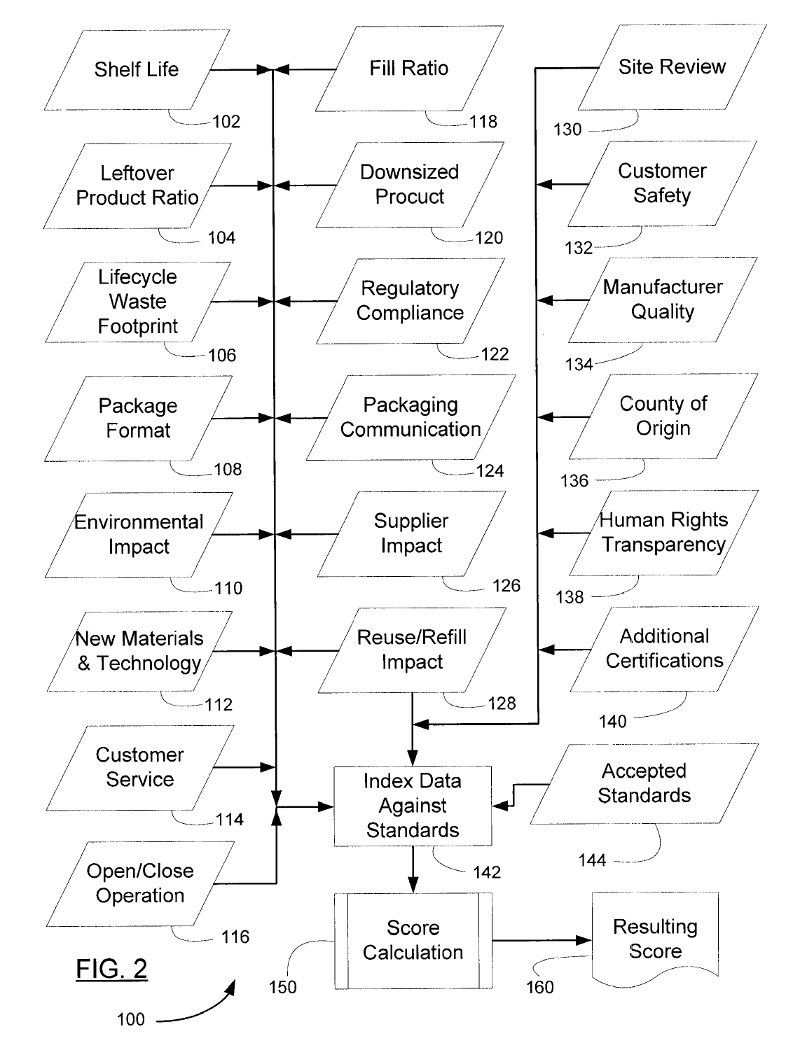

FIG. 2 generally illustrates the Responsible Packaging System and Method scoring process (100), including the different types of data considered. As illustrated in this figure, multiple types of data are provided to an indexing step (142), which is then provided to the overall score calculation step (150). The result of calculation step (150) is a resulting package score (160). To better understand this process, the individual score data is discussed below in additional detail.

Improvement in packaging design and practices requires challenges to existing packaging formats. Responsible packaging ensures that packaging continues to meet all necessary regulatory, safety and hygiene criteria, while being acceptable to the retailer and consumer. That said, responsible packaging further requires packages to be designed to protect, deliver and promote goods in an efficient manner that minimizes the waste of natural resources required to produce, deliver and promote the product. Waste of natural resources and its related effect on our environment occurs at many stages of the packaging life cycle, i.e. creation, transport, storage, promotion, use and disposal. By promoting, rewarding and incentivizing design and distribution methods that optimize the use of natural resources, and by identifying and obligating a minimum requirement necessary to achieve responsible product packaging functions, merchandisers will be motivated to improve existing practices. By reviewing responsible packaging as a system, rather than a selected group of isolated steps, and providing a score for each package lifecycle step where waste is created relative to established responsible packaging waste reduction standards, an improvement in packaging practices can be achieved. The sum of the step scores yields the Package Life Cycle Waste Footprint score and indexes this score against established responsible packaging waste reduction standards. The Package Life Cycle Waste Footprint Score data (106) is used as one input to the overall scoring process (100). Using this process, an objective measure of responsible packaging practices can be realized.

The system and method provided herein also challenges the primary functions of existing packaging formats. As generally understood, the primary functions of responsible packaging within the supply chain are to contain, protect, preserve and promote a product while easing its handling for the duration of its shelf life, all while using a minimum amount of resources and promoting the recyclability of the same. Responsible packaging must have sufficient physical strength to protect, contain and secure the contents during storage, transport, display, and promotion. Appropriate responsible packaging also provides adequate stacking strength and/or a product cushion necessary to resist abrasion, gouging or tearing. Each of these considerations must further be enhanced by using the optimal mix of recyclable elements. Responsible packaging principles provide for a defined minimum level of barrier protection between the contents and the external environment, thus appropriately containing and preserving the product and/or goods, protecting the environment from adverse impacts (such as leaking, leaching or breaching of the oxygen), and providing a sunlight barrier which may increase shelf life leading to the reduced speed of waste production. Responsible packaging principles also further promote a maximum shelf life and reduction in potential product loss from absorption or transmission when stored in reasonable conditions of handling, temperature, humidity and sunlight. Responsible packaging materials must be clean, prevent odor or other contaminants from degrading the product, and protect the contents for what may be a long duration. Each of these protective features must be achieved while also minimizing any harmful effects on the environment when packaged, handled, stored, displayed, used, recovered, or ultimately disposed. The Responsible Packaging System and Method considers the above principles, along with the techniques used for opening and closing product containers to insure they operate satisfactorily and promote shelf life duration, thus minimizing premature obsolescence and a negative environmental impact. The responsible packaging system and method provides a score for each of these features, which are determined based upon the packaging analyzed, to calculate a responsible package format score. This format score is then indexed against established responsible packaging format standards. The Responsible Package format score data (108) is used as one input to the overall scoring process (100).

The information communicated by product packaging is also a consideration in the establishment of a responsible packaging score. Responsible packaging principles further recognize that the box or container provides a vehicle for the display of relevant information to assist in the handling, choice and use of the product. Much of this information is required by law or regulation. Responsible consumer packaging must not be designed to give a false impression of the nature, quantity, or quality of the contents. Additionally, responsible packaging should be of the optimum size, strength, and performance and utilize the maximum possible recyclable materials to complete its lifespan. As one example, unless there is a clear product packaging or environmental justification, double-skinned containers will be scored negatively and disincentivized. However, there are situations where the dual use of packaging is beneficial, such as the ability of a container to support transportation and point-of-sale display. Such dual use which promotes the efficient use of materials will be scored positively during the analysis process. The Responsible Packaging System and Method likewise negatively scores and disincentivizes packaging that attempts to conceal meaningfully smaller net volume within a meaningfully larger or unnecessary outer container. Responsibly packaged products utilize minimal headspace and/or side-space in order to allow for changes in density (e.g. settlement) or volume (e.g. as temperature or atmospheric or subterranean pressures change).

The Responsible Packaging System and Method further certifies that any environmental claim made on the packaging is accurate and capable of being substantiated. Further, any environmental claims will be measured against responsible packaging standards or environmental best practices in order to score the packaging across the spectrum of manufacture, delivery, storage, display, use/reuse, disposal system, and the claims validity in the context of the entire product lifecycle.

Many different considerations are relevant in the Responsible Packaging System and Method scoring process. As another example, responsibly packaged luxury items will be scored negatively if the packaging is excessively elaborate or functionally unnecessary. Further, responsible packaging must be convenient and easy to open for consumers and commensurate with its product protection purpose. Products intended for seniors or users who may have disabilities will be analyzed differently than those reasonably requiring tamper proof and child resistance mechanisms. Positive scores are provided for opening and closing methods that are obvious with clear, concise instructions, and that support the process of opening the packaging and removing the contents with relative ease and in such a manner as to not damage the contents. Further, the dispensing and pouring, as appropriate, should eliminate waste from spillage and upon emptying, any remaining product or residue is minimal. Instructions and graphics must be legible, using plain language and optimally minimal in words and scale, where graphics are clear and easy to understand, for the life of the package. The Responsible Packaging System and Method favorably supports environmentally responsible use of contents and provides incentive when the packaging analyzed provides guidance as to how the product is best used and disposed of in an environmentally responsible manner (e.g. displaying the appropriate symbol for packaging composition so that consumers and recyclers can readily direct the disposal to the correct recovery collection system). Using the above considerations, scores are provided for the packaging analyzed which calculates a Responsible Packaging Communication score and indexes this communication score against established responsible packaging communication standards. Again, the Responsible Package communication score data (124) is used as one input to the overall scoring process (100).

The Responsible Packaging System and Method scoring scheme challenges the practices of many manufacturers where the fill ratio is ignored or obscured by various packaging tactics. The process of responsible packaging analysis negatively scores and discourages packaging that attempts to conceal meaningfully smaller net volume of product within a meaningfully larger or unnecessary outer container. Responsibly packaged products only allow for the bare minimum headspace, or side-space, in order to provide for changes in density (e.g. settlement) or volume (e.g. as temperature or atmospheric or subterranean pressures change). The scoring scheme analyzes and scores the packaging to calculate a Responsible Packaging Fill Ratio score and indexes this score against established responsible packaging fill ratio standards. Similar to the above mentioned scores, the Responsible Package Fill Ratio score data (118) is also used as one input to the overall scoring process (100).

The Responsible Packaging System and Method presents a packaging analysis scheme that challenges the wasteful process where packaging tactics allow for, or are designed to require, meaningful amounts of product to remain within the packaging at the end of the products life cycle. The responsible packaging analysis scheme negatively scores packaging techniques that conceal meaningful amounts of net product volume that remains reasonably inaccessible to the user. As a practical matter, it is not helpful to the score where damaging the package or the remaining contents is necessary in order to gain access to the remainder product. Responsibly packaged products allow for the bare minimum of remainder product to be inaccessible at the end of the product life cycle. The scoring techniques analyze and score the packaging to calculate a Responsible Packaging Leftover Product Ratio score which is indexed against established responsible packaging leftover ratio standards. Consistent with the above scores, the Responsible Package Leftover Product Ratio score data (104) is used as a further input to the overall scoring process (100).

The Responsible Packaging System and Method also challenges the practice where the packaging and labeling is not in compliance with existing regulations. This practice is scored negatively and disincentives are created to discourage packaging that is not in compliance with existing regulations. A Responsible Packaging Regulatory Compliance score is generated for the subject package which is indexed against established responsible packaging compliance standards. Further, the Responsible Package Compliance score data (122) is used as another input to the overall scoring process (100).

The Responsible Packaging System and Method further optimizes and incentivizes the environmental aspects of packaging design, form, function and disposal, thus promoting an optimal balance between the use/reduction of resources throughout the supply chain. In a general manner, environmental impact of products or packaging contributes to global warming (e.g. the use of irresponsible materials), water supply contamination (e.g. waste disposal and recycling issues), endangered items/materials (e.g. material making up the habitat of endangered animals, or materials that are known to be in short natural supply), etc. The scoring process strictly limits the total concentrations of lead, cadmium, mercury or hexavalent chromium. [Responsible packaging concepts help to minimize packaging volume and weight in line with applicable safety, hygiene and product/consumer acceptance.] More specifically, the preferred packaging will provide best practices for recovery (e.g. through best choice/use of ink, coatings, adhesives and other materials) and best use of discarded materials as energy or by composting (re-usable packaging must also be capable of recovery). Further, preferred packaging will minimize the presence of hazardous substances in emissions (ash or leachate, ground or ground water) when packaging waste is incinerated or land filled. To obtain higher scores, packer/fillers need their suppliers of empty packaging (packaging converters) to guarantee that packaging components meet the heavy metal limit requirements and contain minimum noxious materials. The Responsible Packaging System and Method calculates a Responsible Packaging Environmental Impact score which is indexed against established responsible packaging environmental impact standards. Once again, the Responsible Packaging Environmental Impact score data (110) is used as an input to the overall scoring process (100).

As an independent third party carries out the analysis and scoring processes, the system challenges situations where the final packaging contains components made by a number of suppliers. The supplier of the empty packaging is usually unaware of the detailed conditions to which the packaging will be subjected. The Responsible Packaging System and Method grades owners on their management and selection of the packer/filler by insuring the packaging complies with current standards and regulations. In sum, the system scores the packaging to calculate a Responsible Packaging Component Supplier Impact score which is indexed against established responsible packaging component supplier standards. The Responsible Package Component Supplier Impact score data (126) is used as yet another input to the overall scoring process (100).

The Responsible Packaging System and Method supports the development of new materials and new production filling technologies and related processes, thereby causing responsible packaging to be more resource-efficient while maintaining its functional integrity. The Responsible Packaging System and Method further identifies the optimal product size and the targeted consumer demand. In this analysis, unit size and household or unit size and consumer are more highly rated when in equilibrium with established standards, thus minimizing the waste of resources at all stages of the supply chain. In this manner, the Responsible Packaging scheme supports packaging that takes up less space, weighs less and enables better utilization of transportation, warehousing and shelf size footprint. The calculation of a Responsible Packaging New Materials and Technology Impact score is indexed against established responsible packaging standards. To continue providing a comprehensive picture of the packaging, the Responsible Package New Materials and Technology Impact score data (112) is also used as one input to the overall scoring process (100).

Returnable packaging for reuse or refilling, (e.g. drums, cartridges, home refill packaging systems) which provide environmental benefits are strongly encouraged under the present scheme. The hygiene, safety and waste characteristics of such systems are also evaluated in conjunction with environmental impact and effectiveness. Further supported are best practices against established standards for energy recovery and material recycling of disposed packaging. In certain circumstances recycling will rank/score high. In other circumstances, energy recovery is the better environmental option and consequently will rank/score higher. The scoring scheme thus supports responsible packaging efforts that flexibly design packaging to be compatible with energy recovery and recycling schemes. Again, the Responsible Packaging System and Method will calculate a Responsible Packaging Reuse/Refill Impact score which is indexed against established responsible packaging reuse/refill standards. The Responsible Packaging Reuse/Refill Impact score data (128) is used as an additional input to the overall scoring process (100).

A customer service score is also used, which may include (i) consumer feedback (through vote, comment or remarks); (ii) clear, concise and non-confusing labeling, and (iii) verified ease of access to the product manufacturer (via toll free number, email, chat or other electronic means convenient to the consumer and friendly to the environment). The Responsible Packaging System and Method analyses the packaging to calculate a Responsible Packaging Customer Service score which is indexed against established responsible packaging customer service standards. Consistent with the comprehensive scoring concepts involved, the Responsible Packaging Customer Service score data (114) is used as a further input to the overall scoring process (100).

The Responsible Packaging System and Method additionally analyses for manufacturing quality control, which scores, among other things, whether the product manufacturer is ISO Quality Certified. This score addresses the need to eliminate the waste of resources due to packages being shipped with damaged or missing parts. At some level, the existence of ISO certification suggests efficiency of processes within the manufacturing facility. Alternatively, customer feedback could be used to assign a score. The packaging content is analyzed to calculate a Responsible Packaging Manufacturer Quality score which is indexed against established responsible packaging manufacturer standards. The Responsible Packaging Manufacturer Quality score data (134) is used as another input to the overall scoring process (100).

The Responsible Packaging System and Method further analyses packaging shelf life to yield a shelf life score. The score compares the shelf life of the product and/or package to a set of responsible packaging shelf life standards to yield its score. This could be dependent on the relationship of the goods and the packaging to determine how well the package is designed to maintain a reasonable shelf life. The calculated Responsible Packaging Shelf Life score is indexed against established responsible packaging shelf life standards. As shown in FIG. 2, the Responsible Packaging Shelf Life score data (102) is also used as an input to the overall scoring process (100).

The Responsible Packaging System and Method also analyses for downsized product to identify products and packages where the size shrank, but the price was not adjusted commensurately. This considers the situation where certain price points are maintained by offering a smaller size or quantity of the actual product. The downsized product score will compare the current product size and price, i.e. price/size ratio, to the prior responsible packaging standards database to yield its downsized product score. The calculated Responsible Packaging Downsized Product score is then indexed against established responsible packaging downsized product standards. As yet another important aspect of the scoring process, the Responsible Packaging Downsized Product score data (120) is used as a input to the overall scoring process (100).

The Responsible Packaging System and Method also considers how hard it may be to open/close/handle the package. A score is developed to identify products and packages where the tensile strength required to open/close/handle the package or method of opening is inconsistent with the products intended purpose or target audience. According to a responsible packaging standards database of hard to open/close/handle products, a hard to open/close/handle product score is developed. The calculated Responsible Packaging Hard to Open/Close/Handle score is indexed against established responsible packaging open/close/handle standards. Once again, the Responsible Packaging Open/Close Operation score data (116) is used as another input to the overall scoring process (100).

As another consideration, the Responsible Packaging System and Method analyses packaging and design to yield a country of origin score. This country of origin score determines if products and packages clearly indicate the country where the product is made, (e.g. the prominent displaying countries flags or distinguishable marks, according to differing standards). The responsible packaging standards database includes details of responsible packaging and products by country of origin to quantify these perceptions. The country of origin score will be made relative to adherence to the responsible packaging standards. Scores related to a Responsible Packaging Country of Origin score is indexed against established responsible packaging country of origin standards. As a further input to the overall scoring process (100), the Responsible Packaging Country of Origin score data (136) is also used.

The Responsible Packaging System and Method further provides the capability for a site review score to be included, more specifically, where a previous or alternative review of facilities has been completed to examine manufacturing, packaging and process management practices that may affect ethical worker treatment. The site score is determined during a site tour of the manufacturing and packaging facilities where production, assembly and packaging occur, as well as raw material storage and waste stream evaluation. Other site score considerations may include, but are not limited to, ambient and process temperatures, pollution controls, protective worker equipment, and processes to protect workers. Using all information, the site factors are analyzed and a Responsible Packaging Site Review Score is calculated which is indexed against established responsible packaging site score expectations or standards. The Responsible Packaging Site Review score data (130) is used as a further input to the overall scoring process (100).

The responsible packaging system and method further provides the capability for a Consumer Safety Packaging score, which analyzes packaging to determine or consider the potential harmful ways the packaging may impact users. The consumer safety packaging score is determined by analyzing the packaging elements, features and functions, such as opening and closing, to determine the risk level to the consumer or user. Scoring considerations may include, but are not limited to, whether or not a potentially harmful tool is needed to open the packaging, such as a knife or scissors, or whether or not the packaging is flammable, may contain liquids at high temperature, is toxic to humans or pets, or may have small parts that could be ingestible by children. Further, the score will calculate the ratio of the total number of safety complaints, to the total number of packages in a given commercial market, in order to evaluate complaints in a commercial context. The responsible packaging system and method scores these factors and calculates a Responsible Packaging Consumer Safety Score and indexes this score against established responsible packaging consumer safety score standards. The Responsible Packaging Consumer Safety Packaging score data (132) is used as yet an additional input to the overall scoring process (100).

As yet another example of the various factors making up the Responsible Packaging System and Method score, the system recognizes the steps taken by retailers and manufacturers to vet their materials and packaging via other certification companies, or independent third party certification methods that recognize characteristics also beneficial to responsible packaging. Recognizing the common benefits, the system confirms if any other certifications have been awarded and calculates a Responsible Packaging Prior Certification Score which is indexed against established responsible packaging prior certification score expectations or standards. The Responsible Packaging Prior Certification score data (140) is used as another input to the overall scoring process (100).

The Responsible Packaging System and Method also supports the California Transparency in Supply Chain Act of 2010, which requires retailers and manufacturers above a certain size to disclose measures used to track possible slayery and human trafficking in their supply chain. Responsible packaging means the elimination of human rights abuses throughout the supply chain, from materials acquisition to disposal and the effects thereafter, and the fostering of ethical and fair treatment of workers. This act is used as a guideline to create a Responsible Packaging Human Rights Transparency score which is indexed against established expectations or standards. Consistent with the other generated scores, the Responsible Packaging Human Rights Transparency score data (138) is used as an input to the overall scoring process (100).

To insure both product and package safety, the Responsible Packaging System and Method would also provide the capability to evaluate whether a package is undesirably emitting radiation. As is well known, certain products may undergo radiation treatment for any number of reasons. As one example, beef products have often been irradiated to deal with certain contaminates. While the process may be accepted and helpful for the particular product, it is undesirable to have the packaging continue to emit radiation when encountered by the consumer. A responsible manufacturer would certainly take precautions to insure that radiation is no longer emitted from either the product or the package. The Responsible Packaging System and Method can certainly take this into account, and generate a package radiation score, which is then indexed against established expectations or standards. It is recognized that this scoring may not be relevant for a number of different packages, thus this score is not specifically listed in FIG. 2. That said, it is clearly contemplated as an option.

As outlined above, the Responsible Packaging System and Method analyses and measures the numerous aforementioned scores and indices using a predetermined criteria to result in a rating system and process that electronically scores a package or design to determine a responsibility quotient. For reference, a summary of the scoring objectives is attached as Exhibit B, which lists the above discussed considerations. Using the resulting responsibility quotient as one primary indicator, a certified grade of A, B or C may be displayed on future packaging. A certified grade of A is the highest grade followed by certified grades of B and C. Responsible packages that earn the highest grade also earn the opportunity to further be insured from packaging liability while confirming to the consumer that responsible packaging for their organization is a priority. The certified grade of A also qualifies the responsible packager as an Environmental Steward for that package. The present process, system and method with the resulting certified grade, motivates responsible packaging by incentivizing manufacturers, packagers, shippers, retailers and consumers to make smart, informed, environmentally responsible choices.

As mentioned above, the example embodiments provide an analysis methodology or scheme for independently examining packaging designs, materials and practices of others for purposes of determining a responsibility score. Generally speaking, the responsibility score is intended to provide an indicator of the environmental responsibility taken by the manufacturer as they distribute products and materials. The responsibility score is based upon all factors given various weights based upon multiple data sources (e.g. governmental and academic studies, scientific information, consumer feedback, independent evaluation, best practices, established standards, existing laws and regulations, etc.). In addition, an example system is provided to carry out this analysis and assist in the generation of a score. The example systems also communicate the responsibility scoring techniques used to generate a packaging score for the particular product or materials being distributed.

Those skilled in the art will recognize that the ‘packaging’ is broadly defined to include many different product areas. Obviously, product or device packaging is well understood and the general need for responsibility in packaging techniques is established. That said, similar concepts are equally applicable to mailings, liquid distribution, etc. As used herein, packaging is intended to encompass each of these concepts.

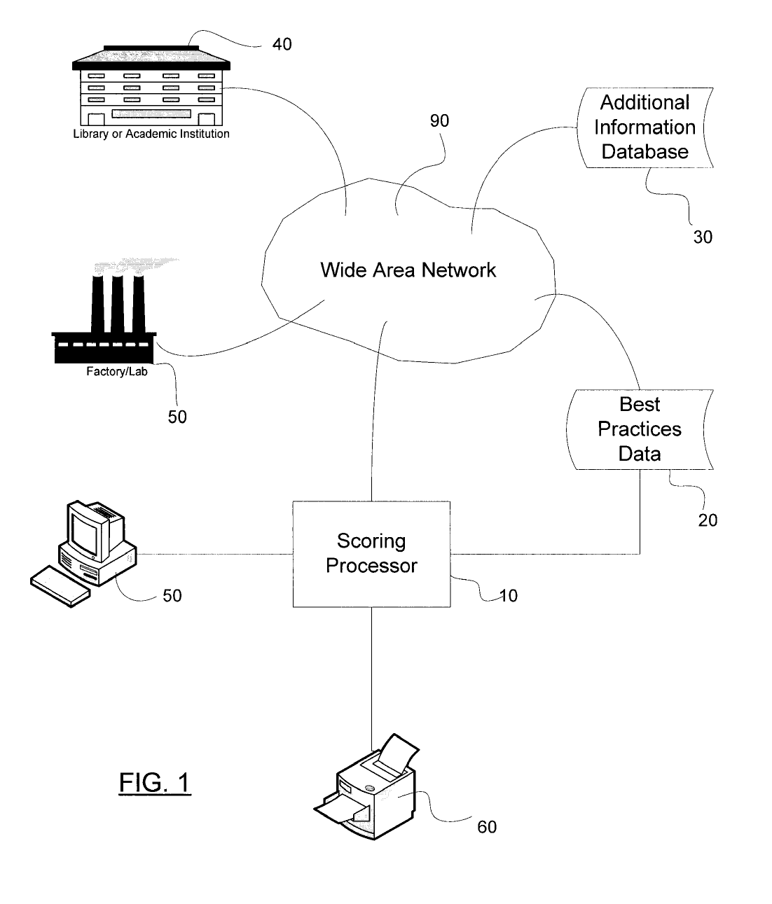

Referring now to FIG. 1, an example schematic is shown which illustrates the various components contemplated in the example embodiment, along with the information flow between relevant parties. In the example, a scoring processor (10) will receive information from a practices database (20). In addition, the scoring processor is attached to a wide area network (90) and could access additional databases (30), libraries or academic institutions (40) and/or factories or scientific research facilities (50). In addition, the scoring processor is attached to a user interface (50) to provide input and output capabilities and to a printer (60) so that certificates and scoring results can be printed when necessary

In order to provide a plurality of scores based upon the multiple criteria for an overall responsible packaging score, one example embodiment uses a plurality of scoring worksheets. Upon review of the multiple criteria listed above, it is clear that many different scores are used to develop an overall responsible packaging score. Attached as Exhibit A is an example worksheet which can be used to generate the inputs to the overall Responsible Packaging score.

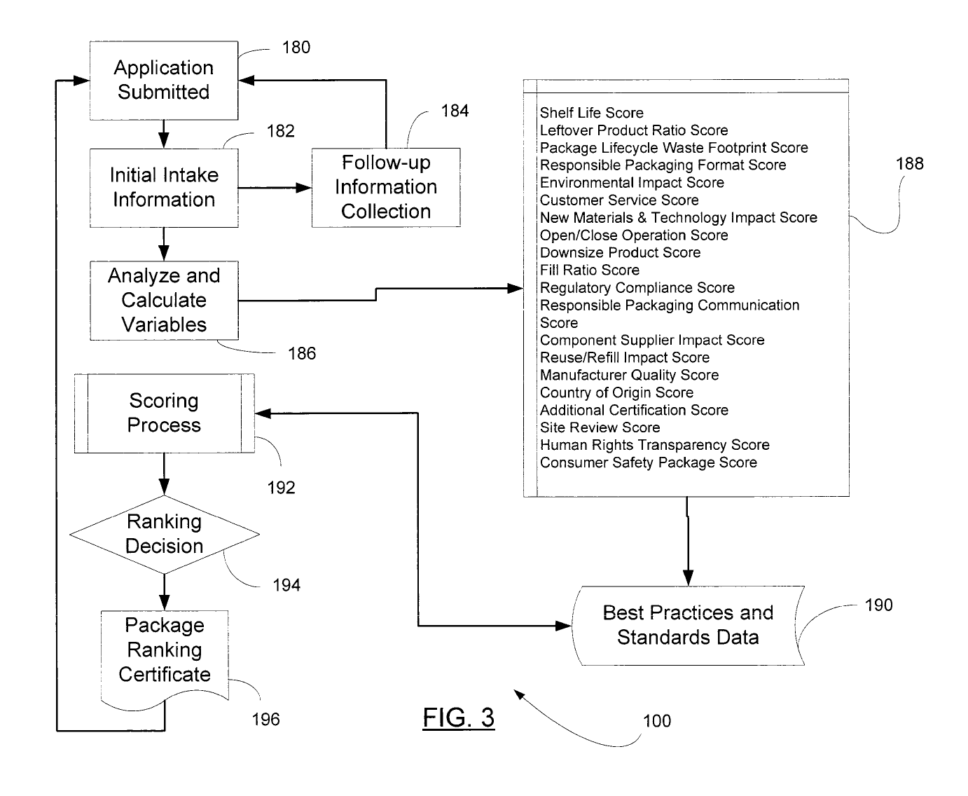

FIG. 3 illustrates a process flow for one example of the overall scoring process (100). As shown, the process will begin with an application being submitted for review (180). As part of the application process, it may be necessary to obtain initial information via an intake process (182), and it may be necessary to collect follow up information (184) via further inquiry to the client submitting the package for review. At this point, the systems will conduct an initial analysis and determine the variable appropriate for the particular product (186). At this point information is collected for each of the various characteristics. Appropriate types of data (i.e. scores) are located in a stored data set (188), which can then be compared with best practices and standards data (190). With all of this information, the predetermined scoring process (192) will conduct all necessary calculations and considerations. At this point, an overall package score is developed. Based upon predetermined raking characteristics, a decision process (194) uses the package score to make a determination of the appropriate rank or certificate. In one example, three ranks are contemplated—“A”, “B” or “C”. Once the desired rank is determined, an appropriate ranking certificate (196) is issued

In one embodiment of the scoring process (192), the total number of eligible responsible packaging scores are determined and identified (designated as RPS₁, RPS₂, RPS₃ . . . RPSₙ, where n=total number of eligible responsible packaging scores). Next, the Responsible Package Performance (RP̂3) and responsible packaging performance standards (RP̂3S) are monitored for each package. Net responsible packaging scores (NRP̂3S) are then calculated for each package using:

NRP̂3Sₙ=ΣRP̂3Sₙ−ΣRP̂3ₙ

As is obvious from the equation above, multiple factors contribute to the overall packaging score. The score is then used to generate a packaging grade, which can be awarded or assigned to the packaging involved. In another example, weighting can be applied to the various factors based upon established priorities. For example, analysis and scientific data may suggest that certain criteria are significantly more important than others. In this case, substantial weighting can be applied to the more significant criteria.

As suggested above, the combination of various factors results in a responsibility score indicative of best practices in the packaging of products or materials. In an alternative example certain priorities may be highlighted or emphasized. Using one theory, the Pareto Principle offers a method to bring clarity to the analysis carried out by the example systems. This principle is appropriate in several complex situations and problems, especially when deciding where to focus effort and resources. The Pareto Principle (at a simple level) suggests that where two related data sets or groups exist (typically cause and effect, or input and output):

“80% of output is produced by 20% of input.” or alternatively,

“80% of outcomes are from 20% of causes”

Examples of Pareto's Principle as it applies to various situations as a guide, not a scientific certainty, that within any given scenario or system or organization:

80% of results come from 20% of efforts

80% of activity will require 20% of resources

80% of usage is by 20% of users

80% of the difficulty in achieving something lies in 20% of the challenge

80% of revenue comes from 20% of customers

80% of problems come from 20% of causes

80% of profit comes from 20% of the product range

80% of complaints come from 20% of customers

80% of sales will come from 20% of sales people

80% of corporate pollution comes from 20% of corporations

80% of work absence is due to 20% of staff

80% of road traffic accidents are caused by 20% of drivers

80% of a restaurant's turnover comes from 20% of its menu

For any particular situation, the precise ratio can and probably will be different than 80:20, but it has been well established in several situations and can be applied as a general rule. Such a principle is useful in planning, analyzing, trouble-shooting, problem solving, decision-making, and change management, especially when broad initial judgments have to be made.

As an example, consider an organization, which persists in directing its activities equally across its entire product range when 95% of its profits derive from 10% of the products, and/or 2% of its profits come from 60% of its product range. The same effect can be seen in markets, services, product content, resources, etc., indeed, any situation where an ‘output/input’ or ‘effect/cause’ relationship exists.

Applying the Pareto Principle to the responsible packaging practices and scoring outlined above suggests that a set of select inputs could be used to streamline the scoring process. As one example, using the multiple factors illustrated in FIG. 2, it would likely be beneficial to generate a packaging score based upon only (i) fill ratio, (ii) package format, (iii) environmental impact, and (iv) new materials & technology. The inclusion of various factors is obviously a choice, but selecting four of eighteen (i.e. 22.2%) would provide meaningful information.

As an alternative method of scoring, the following methodology could be incorporated:

RPI Score=(% of IV1 to Total*Weight1)+(% of IV2 to Total*Weight2)+(% of Ivn*Weight)/(# of IV's)*100

Where:
IV=Independent Variable
Weight=an RPI scoring weight for the independent variable based on RPI, historical or regulatory standards

Using this calculation, a grade could be applied, such as an A, B or C grade. The following standards are contemplated as one example:
A A high RPI Formula score that indicates few if any issues with the packaging for the environment and/or consumers.
B A moderate RPI Formula score that indicates limited to moderate issues with the packaging for the environment and/or consumers, where an improvement plan is provided and recommended.
C A low RPI Formula score that indicates excessive material issues with the packaging for the environment and/or consumers, where an improvement plan is provided or a phase out is recommended.

Using this example analysis, the score is awarded and can thus be assigned to a particular package. It will then be beneficial to mark the packages accordingly, depending upon the desires of the manufacturer, and/or the requirements of the retailer.

Those skilled in the art will further appreciate that the present invention may be embodied in other specific forms without departing from the spirit or central attributes thereof. In that the foregoing description of the present invention discloses only exemplary embodiments thereof, it is understood that other variations are contemplated as being within the scope of the present invention. Accordingly, the present invention is not limited in the particular embodiments which have been described in detail herein. Rather, reference should be made to the appended claims as indicative of the scope and content of the present invention.

What is claimed is:

1. A method for analyzing and grading product packaging, comprising:
measuring a plurality of physical characteristics for the product packaging and inputting a plurality of corresponding physical characteristics scores into a scoring system;
determining a plurality of material use characteristics for materials used in the product packaging and inputting a plurality of corresponding material use characteristics scores into the scoring system;
reviewing a plurality of relationship details indicative of the relationship between the product packaging and the contents of the product packaging, calculating a plurality of corresponding relationship scores and inputting the plurality of relationship scores into the scoring system;
reviewing a plurality of use characteristics indicative of the how the product packaging is used, calculating a plurality of product package use scores and inputting the plurality of product packaging use scores into the scoring system;
evaluating a plurality of producer characteristics related to operations of product producer, generating a plurality of producer characteristic scores and inputting the plurality of producer characteristic scores into the scoring system;
calculating an overall package score based upon the corresponding physical characteristics scores, the plurality of corresponding material use scores, the plurality of corresponding relationship scores, the plurality of product package use scores and the plurality of producer characteristic scores, wherein the overall package score is calculated using a predetermined formulation which accounts for a plurality of predetermined industry standards for the physical characteristics, material use characteristics, the relationship details, the product packaging use characteristics and producer characteristics; and
outputting the overall package score.

2. The method of claim 1 wherein the physical packaging characteristics comprise format characteristics, alternative certification characteristics, and customer safety characteristics.

3. The method of claim 1 wherein the material use characteristics comprise shelf life characteristics, lifecycle waste footprint characteristics, environmental impact characteristics, and new material characteristics.

4. The method of claim 1 wherein the relationship details comprise leftover product characteristics, fill ratio characteristics, and product downsize characteristics.

5. The method of claim 1 wherein the product packaging use characteristics comprise open/close operation characteristics.

6. The method of claim 1 wherein the producer characteristics comprise customer service characteristics, quality characteristics, source characteristics, site characteristics, and human rights characteristics.

7. A method for analyzing packaging and providing a responsible packaging and labeling certification system, said method comprising the steps of:
receiving a package for analysis;
reviewing the package against a plurality of predetermined responsible packaging criteria, and generating a corresponding plurality of scores based upon the Responsible Packaging criteria; and
determining a Responsible Packaging score using the plurality of scores and a predetermined scoring schedule.
